(19) United States
(12) Patent Application Publication
(10) Pub. No.: US 2017/0348080 A1
(43) Pub. Date: Dec. 7, 2017

(54) REUSABLE FLOSS HANDLE WITH A REPLACEMENT FLOSS MEMBER

(71) Applicant: William Battaglia, North Haledon, NJ (US)

(72) Inventor: William Battaglia, North Haledon, NJ (US)

(21) Appl. No.: 15/367,322

(22) Filed: Dec. 2, 2016

Related U.S. Application Data
(63) Continuation-in-part of application No. 15/172,868, filed on Jun. 3, 2016.

(51) Int. Cl. A61C 15/04; A61C 17/00

(52) U.S. Cl. CPC A61C 15/048; A61C 17/00

(57) ABSTRACT

An oral care device is provided that both simultaneously flosses between teeth and scrapes a tooth surface. The oral care device includes flat floss having a rectangular cross section and a piece of material having greater stiffness than the flat floss directly overlaying an outer surface of the flat floss. The piece of material acts as the scraper and is at least partially arcuate in cross section.

### CROSS REFERENCE TO RELATED APPLICATIONS

This application is a continuation in part application of prior co-pending U.S. patent application Ser. No. 15/172,868, filed on Jun. 3, 2016; the entirety of which is incorporated herein by reference.

### BACKGROUND

### Technical Field

Generally, the present disclosure relates to flossing devices. More particularly, the present disclosure relates to a flossing wand having a handle with a removable floss frame. Specifically, the present disclosure relates to a flossing device including a handle and a floss frame selectively lockable with the handle with an improved locking assembly and orientation of the floss string in the locked position.

### Background Information

Dental floss is a thin filament or wire ordinarily used to remove food or dental plaque from between teeth, typically in areas where a toothbrush is unable to reach. Dentists suggest that a significant amount of dental plaque may be removed through the act of flossing and the removal of the dental plaque is essential to prevent dental diseases such as gingivitis.

Floss ordinarily comes on a spool configured to be unwound and cut by the user when the act of flossing is about to occur. Others have recognized that unwinding floss from a spool and using hands to maneuver the floss through the teeth may be unwieldly in some instances.

As such, others have developed handheld tools which are commonly referred to as floss wands to assist a user in flossing their teeth. These floss wands ordinarily have a handle and a short piece of floss string supported by a U-shaped frame. In some instances, the floss carrying frame may be removable relative to the handle.

Some exemplary floss wands including a handle and a removable frame are depicted in U.S. Patent Application Publication No. 2006/0169299; U.S. Patent Application Publication No. 2008/0041412; U.S. Patent Application Publication No. 2007/0044815; U.S. Patent Application 2004/0040571; U.S. Patent Application 2004/0040572; and U.S. Pat. No. 7,171,971. Additionally, some exemplary flosses that are combinations of two or more different materials are depicted in U.S. Pat. No. 5,433,226.

### SUMMARY

The aforementioned references generally disclose floss wands having a handle and a removable floss frame. However, these references are not without their drawbacks. Particularly, they include handles that are elongated similar to that of a toothbrush which can be difficult to maneuver in the small confines within a user's mouth. Additionally, some of the locking features utilized to attach the removable floss frame to the handle may lack integrity when subjected to forceful pressure by the operator attempting to maneuver the floss between the teeth. As such, issues continue to exist with flossing wands having removable floss heads or removable floss frames and therefore a need continues to exist to cure these drawbacks. Additionally, a need exist for a piece of floss that is incorporated with a different second material acting as an inter-teeth scraper. The present disclosure addresses these and other issues.

In one aspect, an exemplary embodiment of the present disclosure may provide a flossing device comprising: a handle extending from a first end to a second end defining a longitudinal direction therebetween; a first arm on the handle and a second arm on the handle offset from the first arm, and the first and second arms define a space therebetween; a locking assembly on the handle adjacent the first and second arms; a slot formed in the first and second arms, wherein the slot is lengthwise aligned in the longitudinal direction; a floss frame member carrying taught floss and a portion of the floss frame member shaped complementary to the slot for slidable engagement therewith; wherein the locking assembly selectively locks the floss frame to the handle when the floss frame is in the slot.

In one aspect, an exemplary embodiment of the present disclosure may provide a method of comprising the steps of: providing a handle including a first end opposite a second end defining a longitudinal direction therebetween and a first side opposite a second side defining a transverse direction therebetween; aligning taught floss carried by a floss frame lengthwise in the longitudinal direction; moving the floss frame in the transverse direction into a slot defined adjacent the first end of the handle; and locking the floss frame to the handle with a locking assembly.

In one aspect, an exemplary embodiment of the present disclosure may provide a flossing device including a handle and a selectively lockable floss frame carrying a taught floss string. The flossing device locks the floss frame to the handle to position the taught floss lengthwise parallel to the longitudinal axis associated with the handle. A locking assembly effectuates the selective locking engagement of the floss frame to the handle. The locking assembly may be positioned adjacent two arms formed in the handle defining a slot configured to slidably receive the floss frame.

In another aspect, an exemplary embodiment of the present disclosure may provide an oral care device adapted to simultaneously both floss between teeth and scrape a tooth surface, the oral care device including flat floss having a rectangular cross section and a piece of material having greater stiffness than the flat floss directly overlaying an outer surface of the flat floss, wherein the piece of material is at least partially arcuate in cross section.

In another aspect, an exemplary embodiment of the present disclosure may provide a device comprising: a scraper including a plurality of convex surfaces facing formed from a first material adapted to scrape against a tooth surface; a piece of flat floss formed from a different second material having a non-arcuate cross section connected the plurality of convex surfaces adapted to floss between teeth; wherein the device is adapted to both floss between teeth and scrape a tooth surface within a user's mouth. A further embodiment of this device may provide a frame carrying the piece of flat floss; and a handle that selectively connects with the frame. A further embodiment of this device may provide a locking assembly on the handle to effectuate the selective connection between the handle and the frame. A further embodiment of this device may provide wherein the plurality of convex surfaces of the scraper are uniformly formed from an elastomer material attached to an outer surface of the flat floss. A further embodiment of this device may provide wherein the scraper defines linear segments extending angularly from the plurality of convex surfaces. A further embodiment of this device may provide wherein at least one linear segment crosses over an edge of the flat floss at an angle in a range from 15° to 75°. A further embodiment of this device may provide an arcuate profile of the convex surfaces in cross section; a planar profile of the flat floss in cross section; wherein the arcuate profile is exterior the planar profile. A further embodiment of this device may provide an end plane associated with a frame carrying the flat floss; at least one apex of one curved surface from the plurality of curved surface coplanar with the end plane. A further embodiment of this device may provide a longitudinal first edge and a longitudinal second edge on the flat floss; a transverse floss width measured from the first edge to the second edge; wherein a portion of the plurality of convex surfaces is exterior to the first and second edges defining a greater transverse width associated with the plurality of convex surfaces. A further embodiment of this device may provide wherein the plurality of convex surfaces are entirely exterior of an outer surface of the flat floss.

In another aspect, an embodiment of the present disclosure may provide an oral care device comprising: a first end and a second end; a handle defining the second end; a scraper proximate the first end; and a piece of flat floss proximate the first end, wherein the flat floss and the scraper may be in direct contact. A further embodiment of this device may provide a frame selectively attachable to the handle; wherein the frame carries the piece of flat floss and the scraper. A further embodiment of this device may provide a convex surface of the scraper contacting a planar surface of the flat floss. A further embodiment of this device may provide at least a portion of the scraper formed from an elastomer material. A further embodiment of this device may provide a lateral width of the scraper greater than a lateral width of the piece of flat floss. A further embodiment of this device may provide a transverse width of the scraper greater than a transverse width of the piece of flat floss. A further embodiment of this device may provide longitudinal first edge spaced from a longitudinal second edge on the flat floss; and at least a portion of the scraper positioned above the first edge at an angle in a range from 15° to 75°. A further embodiment of this device may provide two linear segments of the scraper angularly oriented from one another at an angle greater than 90°. A further embodiment of this device may provide wherein the two linear segments are angularly spaced 120° from one another. A further embodiment of this device may provide a locking assembly on the handle to selectively lock a U-shaped frame to the first end of the handle; wherein the U-shaped frame carries the flat floss and the scraper, and a longitudinal axis of the flat floss is parallel to a longitudinal axis of the handle.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a first side perspective view of a flossing device in accordance with the present disclosure;

FIG. 2 is a second side perspective view of a flossing device;

FIG. 3 is an exploded first side perspective view of the flossing device;

FIG. 4 is an exploded second side view of the flossing device;

FIG. 5 is an enlarged second side perspective view of the region labeled “See FIG. 5” in FIG. 4;

FIG. 6 is an exploded elevation view of the flossing device;

FIG. 7 is an exploded cross section view taken along line 7-7 in FIG. 6;

FIG. 8 is an elevation view of the assembled flossing device;

FIG. 9 is a cross section view of the assembled flossing device taken along line 9-9 in FIG. 8;

FIG. 10 is a perspective view of an alternative embodiment of a floss frame carrying flat floss connected with a material defining a scraper;

FIG. 11 is a side view of the floss frame depicted in FIG. 10;

FIG. 12 is a lateral cross section taken along line 12-12 in FIG. 11;

FIG. 13 is an enlarged view of the encircled region labeled “SEE FIG. 13” in FIG. 12;

FIG. 14 is a transverse cross section taken along line 14-14 in FIG. 11;

and

FIG. 15 is an enlarged view of the encircled region labeled “SEE FIG. 15” in FIG. 14.

Similar numbers refer to similar parts throughout the drawings.

### DETAILED DESCRIPTION

A flossing device is depicted in accordance with one aspect of the present disclosure throughout the figures and is generally indicated at 10. Flossing device 10 provides an operator the ability to floss and clean the spaces between their teeth and gums in their mouth. Flossing device 10 includes one exemplary advantage of providing a reusable member in combination with a disposable floss member which clearly is beneficial in reducing waste.

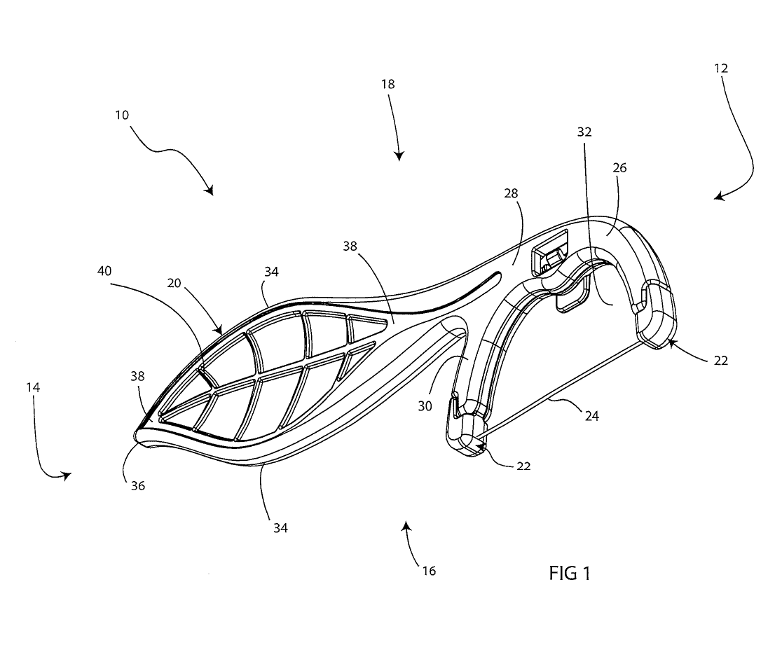

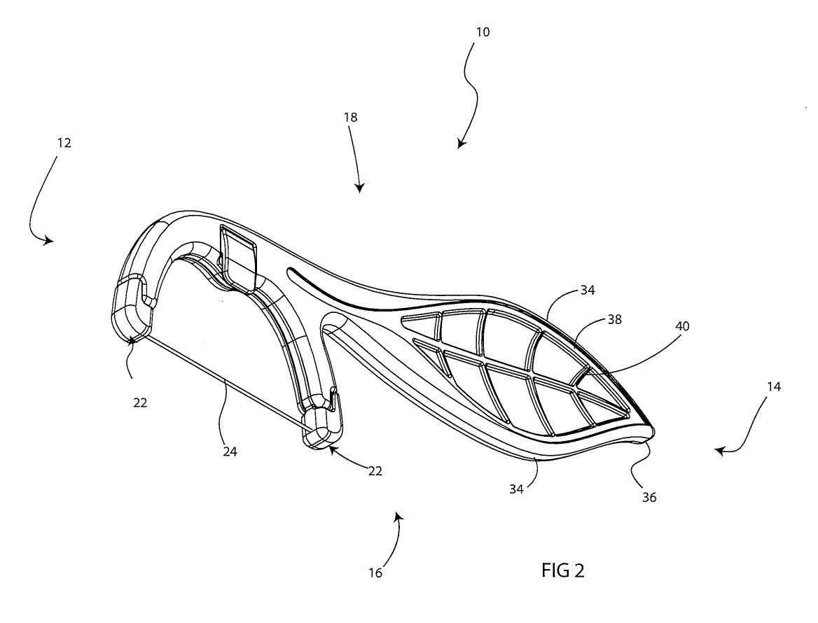

As depicted in FIG. 1 and FIG. 2, flossing device 10 includes a first end 12 opposite a second end 14 defining a longitudinal direction therebetween. Additionally, flossing device 10 includes a first side 16 spaced opposite a second side 18 defining a transverse direction therebetween.

Flossing device 10 further includes a handle member 20 and a replaceable and interchangeable frame 22 supporting a taught floss string 24.

Handle 20 includes a first arm 26 defining the first end 12 extending transversely outward from a rounded connection with a longitudinally extending body member 28. A second arm 30 is offset from first arm 26 closer to second end 14 and extends transversely in the same direction as first arm 26 from a rigid connection with body member 28. The first arm 26 and the second arm 30 define a space 32 therebetween. Collectively, the first arm 26, a portion of the body member 28, and the second arm 30 are generally arranged in a U-shaped configuration when viewed from above. The space 32 defined between first arm 26 and second arm 30 is configured and adapted to receive portions of teeth therebetween during the flossing process when the flossing device 10 is maneuvered by the operator.

A portion of the body member 28 extends longitudinally towards the second end 14 from the rigid connection with second arm 30. In one implementation, the body member 28 extends arcuately outward to an apex region 34 having a maximum transverse width across the apex and then tapering down to a point 36 which defines the second end 14. Intermediate the apex portions 34 may be a recessed region 38. The recessed region 38 may define a plurality of channels 40 arranged in a manner to provide the dual function of an aesthetically pleasing look to increase the commercial viability of flossing device 10 as well as to provide gripping functions to enable the operator to increase their tactile maneuverability of flossing device 10 during the flossing operation. Furthermore, as indicated in both FIG. 1 and FIG. 2, a complementary, or otherwise mirrored, recessed region 38 may be formed in both surfaces of handle 20. Similar reference numerals are identified on each side as referring to similar elements on each lateral side of flossing device 10.

The channels 40 may be formed in a geometric configuration or other commonly known organic or inorganic configurations to simulate the look and feel of a commonly appreciated item for an operator. For example, a geometric pattern may be established with channels 40 in the shape of a leaf wherein the channels form the veins of the leaf or the channels 40 may be arranged in a geometric pattern such as one similar to that of a beehive. Clearly, other patterns are entirely possible and the pattern shown in the figures is not intended to be limiting.

With continued reference to the recessed region 38, the region 38 may be offset entirely towards second end 14 relative to second arm 30. However, other implementations, such as the one shown in FIG. 1, may have a small tail portion of the recessed region 38 which extends towards the first end 12 beyond the connection of second arm 30 to body member 28.

Handle 20 has a longitudinal length between two inches and three inches measured from first end 12 to second end 14. This is considerably shorter than a traditional toothbrush handle, or a prior art floss wand handle found in U.S. Patent Application Publication No. 2006/0169299; U.S. Patent Application Publication No. 2008/0041412; U.S. Patent Application Publication No. 2007/0044815; and U.S. Pat. No. 7,171,971 which are in a range from about six inches to about eight inches.

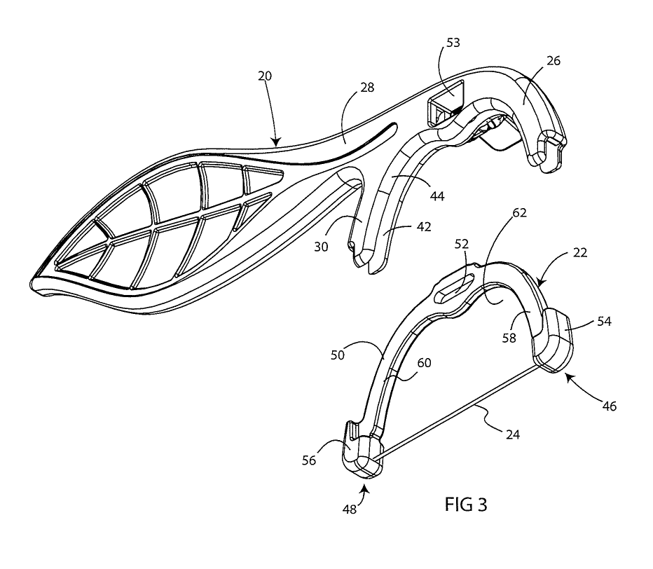

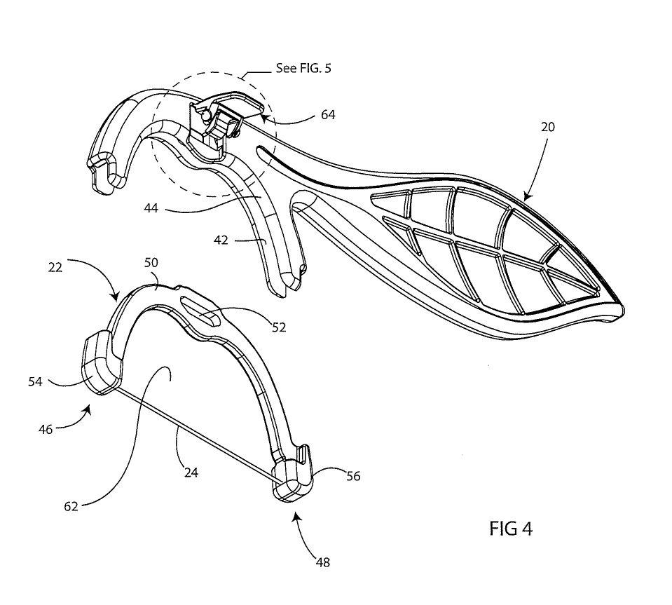

As depicted in FIG. 3 and FIG. 4, the handle 20 defines a slot 42 in the first arm 26 and the second arm 30 and the slot 42 receives floss frame 22 therein. More particularly, slot 42 extends transversely and is formed in second arm 30 and faces gap 32. The slot 42 continues in a longitudinal direction and is formed in the body member 28 facing gap 32. The slot 42 then continues to be formed by first arm 26 extending transversely a distance similar to that of second arm 30. Slot 42 is generally U-shaped in cross section and sized to receive a portion of floss frame 22 therein and establish a nesting fit. A majority of slot 42 is coplanar with handle 20. Stated otherwise, slot 42 is oriented lengthwise in the longitudinal direction. Accordingly, slot 42 permits sliding movement of the floss frame 22 in the transverse direction into and out of engagement with slot 42 while simultaneously and substantially precluding movement of frame 22 in the longitudinal direction between first end 12 and second end 14. Immediately adjacent the slot 42 may be an angled transitional wall 44 extending between slot 42 and the outer surface of handle 20.

With continued reference to FIG. 3 and FIG. 4, the floss frame 22 may be a substantially rigid member including a first end 46 and a second end 48. A generally arcuate intermediate member 50 extends between first end 46 and second 48. Intermediate member 50 has a cross section configuration complementary to that of slot 42 inasmuch as intermediate member 50 is configured to be substantially received in slot 42 when the floss frame 22 is attached to handle 20. Adjacent the apex of intermediate member 50 is a laterally extending aperture 52. As will be described in greater detail below, aperture 52 is configured to align with a laterally aligned aperture 53 formed in body member 28 intermediate first arm 26 and second arm 30.

Frame 22 may further include a first enlarged member 54 which defines first end 46 and a second enlarged member 56 which defines second end 48. The first and second enlarged members 54, 56 include an outer width that is substantially similar to first arm 26 and second arm 30 respectively and greater than the width of intermediate member 50. Floss string 24 extends longitudinally between a substantially fixed connection with first enlarged member 54 and second enlarged member 56 on frame 22. Floss string 24 is a conventional string of dental floss that is generally circular in cross section.

The intermediate member 50 includes a first leg 58 and a second leg 60 with the apex portion defining aperture 52 positioned therebetween. Leg 58 and leg 60 define a gap 62 therebetween. Gap 62 is similarly shaped to gap 32 defined in handle 20.

As depicted in FIG. 4 and FIG. 5, flossing device 10 may further comprise a locking assembly 64 provided adjacent the first end 12 of handle 20 in order to selectively lock a single floss frame 22 to handle 20 at a single time. Locking assembly 64 is selectively lockable and unlockable to effectuate the removal and replacement of the interchangeable and disposable floss frames 22.

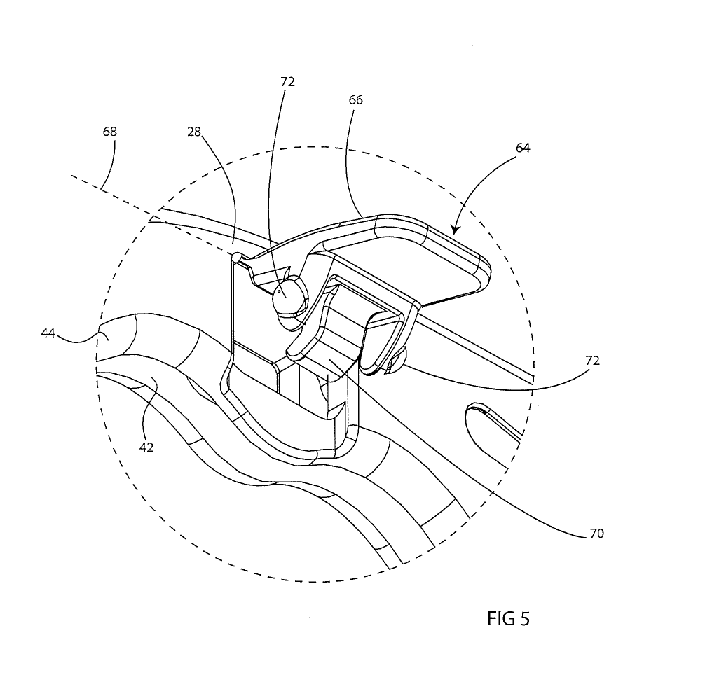

Locking assembly 64 may include a plate 66 pivotally connected to body member 28 of handle 20 and is configured to move between a first unlocked position (FIG. 5) and a second locked position (FIG. 6) about pivot axis 68. The pivot connection between plate 66 and body member 28 of handle 20 is positioned closer to second side 18 such that plate 66 rotates towards second side 18 when moving from the second locked position to the first unlocked position and the plate 66 moves toward first side 16 when pivoting from the first unlocked position to the second locked position.

A lock arm 70 may extend from a rigid connection with plate 66 and is configured to extend through the aligned aperture 53 on body member 28 and aperture 52 on floss frame 22 when the floss frame 22 is fully inserted within slot 42. Further, the lock arm 70 may include a hooked end 76 configured to extend fully through aperture 52 on frame 22 to thereby ensure a rigid releasable connection of frame 22 to handle 20. This ensures that when frame 22 is secured and selectively locked, the frame is substantially precluded from moving in the transverse direction which is beneficial during the flossing operation. Particularly, an operator does not want floss frame member 22 to move relative to handle 20 as the floss string 24 is maneuvered between teeth and around the operator's gums.

Locking assembly 64 may further include one or more protrusions 72 extending outwardly from a portion of locking assembly 64 configured to engage a recessed portion of the body member 28 that defines aperture 53. In one embodiment, protrusions 72 engaged with the recess adjacent aperture 53 act as one or more detents to assist with the arrest of the rotational movement of plate 66 about pivot axis 68 in the locked position.

While the locking assembly 64 is shown intermediate first arm 26 and second arm 30 on handle 20, it should be clearly understood and foreseen to one having ordinary skill in the art that the locking assembly 64 may be positioned at other locations relative to handle 20 in order to releasably and rigidly secure floss frame 22 carrying floss string 24 to handle 20. Additionally, locking assembly 64 locks frame 22 in longitudinal coplanar alignment with handle 20. While the embodiments shown herein provide a floss string 24 that is lengthwise longitudinally aligned with the longitudinal axis of handle 20, there may be some implementations where a handle 20 could be provided with a slot and a locking assembly that locks a repeatably interchangeable and disposable floss frame member 22 in an arrangement such that the floss string 24 is lengthwise arranged orthogonal relative to the longitudinal axis associated with handle 20.

In accordance with one aspect of an embodiment of the present disclosure, flossing device 10 provides the advantages of a removable and interchangeable floss frame 22 carrying a flossing string 24 that may be releasably attached via locking mechanism 64 to the handle 20. Device 10 enables the handle 20 be reused and recycled rather than conventional disposable single-use floss members that are a unibody design having a handle and a string carrying frame formed as a single unit wherein the entire unit is disposed after the flossing operation.

In accordance with another aspect of the present disclosure, flossing device 10 may be sold as part of a kit which includes one or more handles 20 sold in a package with a plurality of string frames 22 carrying single use flossing strings 24. The kit may be provided as an entire package to provide an operator with a sufficient supply of handles and interchangeable and disposable floss frames 22 for a given period of time. For example, inasmuch as frames 22 are intended to be single use frames, the kit may be sold with one handle and seven frames 22 to represent a kit that should last one week. Alternatively, other numerical arrangements may be provided as one having ordinary skill in the art would understand, such as fifteen frames 22 which would approximately correspond to a half-month supply. A second kit may also be provided as a supplemental package to the original kit which may solely include a plurality of frames 22 which may be purchased by a consumer after acquiring/purchasing the original handle 20.

In operation and with reference to FIG. 6 through FIG. 9, the flossing device 10 enables an operator to reuse handle 20 multiple times while interchanging floss frame 22 carrying floss string 24 for each use or a number of uses until floss string 24 has exhausted its useful life (typically one flossing session).

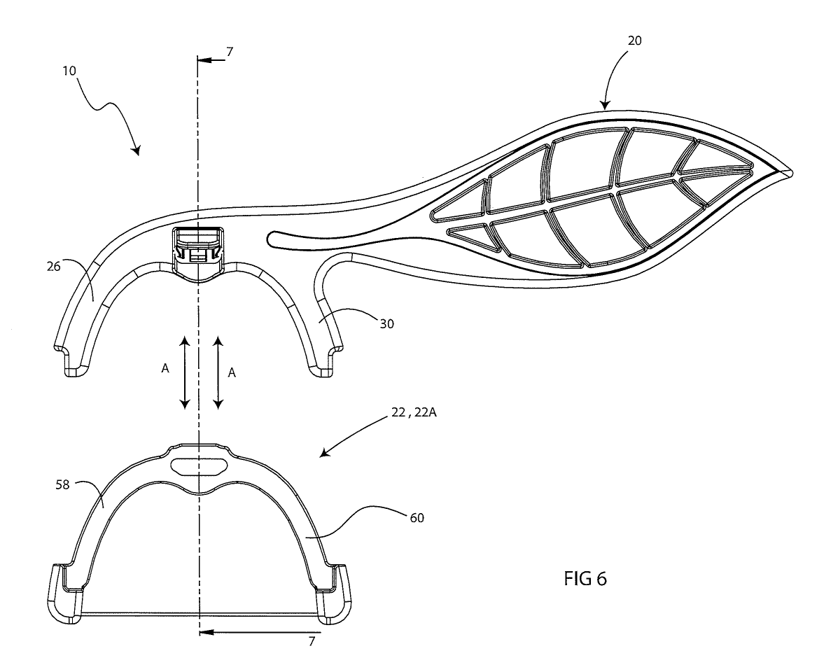

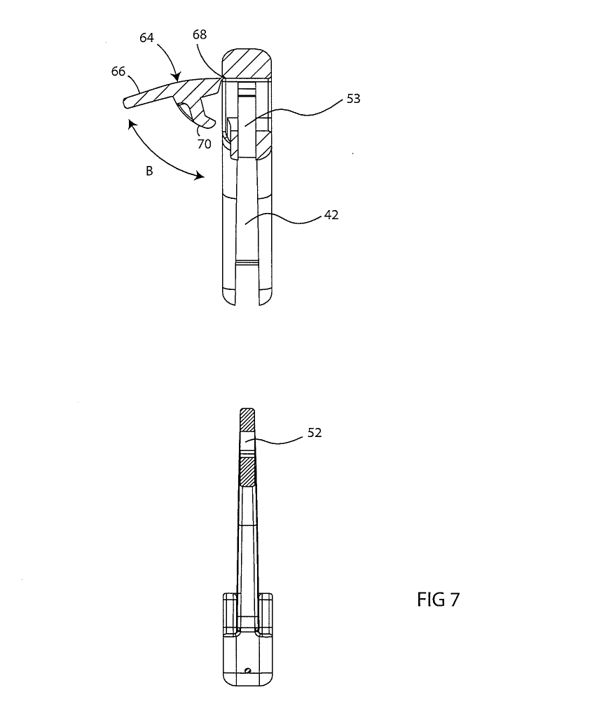

As depicted in FIG. 6 and FIG. 7, a first floss frame 22A is shown in a disconnected position from handle 20. The unattached and disconnected position enables the first floss frame 22A to be aligned with handle 20 as shown in FIG. 6 and FIG. 7. When the disconnected and aligned first floss member 22A is moved into position for attachment with handle 20, the first floss frame 22A is preferably below the downwardly facing slot 42. First floss frame 22A may be moved upwardly in the transverse direction, shown generally as Arrow A, while simultaneously being centered between first arm 26 and second arm 30. As first floss frame 22A is advanced into an engaged position with handle 20, the first leg 58 on floss frame 22A nests within the portion of slot 42 defined by first arm 26. Simultaneously, the second leg 60 on floss frame 22A nests within the portion of slot 42 formed in second arm 30 on handle 20.

FIG. 7 depicts the locking assembly 64 in an open position wherein the plate 66 has been pivoted about axis 68 in the direction of arrow B such that lock arm 70 is not extending through aperture 53. Rather, lock arm 70 is disposed entirely to one lateral side of handle 20.

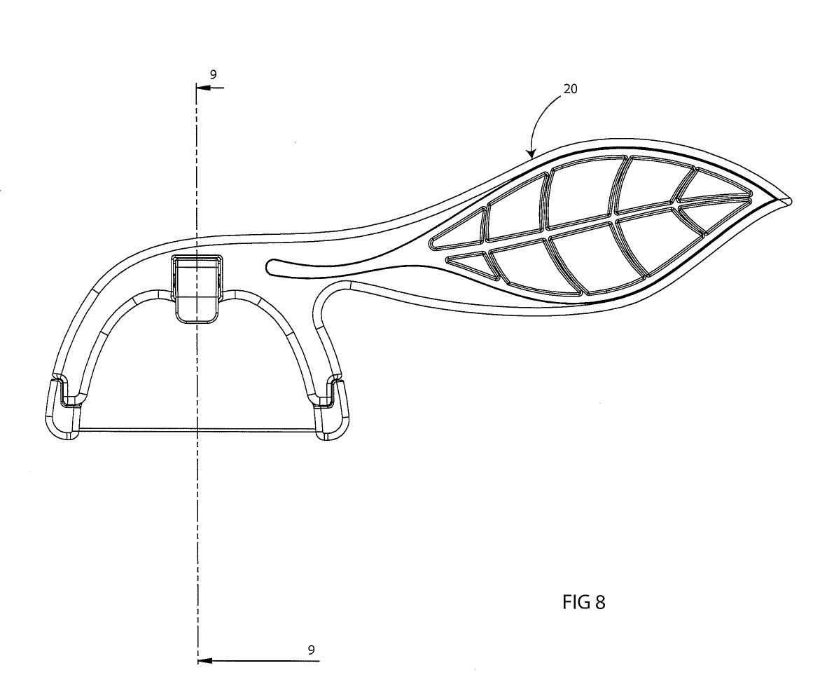

FIG. 8 and FIG. 9 depict the first floss frame 22A engaged with handle 20 with the locking assembly 64 shown in its locked position. Leg 58 and leg 60 on floss first frame 22A nest entirely within slot 42. The enlarged members 54, 56 extend downwardly below the terminal ends of slot 42. When first floss frame 22A is engaged with handle 20, a substantial portion of first floss frame 22A is coplanar with the longitudinal portions of handle 20. Specifically, first floss frame 22A is aligned coplanar with handle 20 along longitudinal plane 74.

Once first floss frame 22A has been fully inserted into slot 42, the locking assembly 64 may be rotated about pivot axis 68 in the direction of arrow B such that the locking arm 70 extends through the aligned apertures 52, 53. The locking arm 70 includes an upwardly extending protruding and hooked terminal end 76 which extends in a vertical direction beyond the uppermost edge of aperture 52 formed in an apex region of member 50 intermediate of leg 58 and leg 60.

When the locking assembly 64 is locked and the frame 22 is held securely in slot 42, a terminal end of plate 66 may be positioned offset from the body member 28. The terminal end of plate 66 opposite the pivot connection at axis 68 is disposed within gap 32. The purposeful elongation of plate 66 into gap 32 in the locked position provides the user/operator an effective gripping means to unlocked the locking assembly from the locked position in order to remove frame 22 from slot 42. Effectively, the advanced terminal end of plate 66 provides a pull tab for the operator to grip and rotate plate 66 back to the unlocked position. Furthermore, while the locking assembly is shown as being part of the handle 20 (and distinct from the floss frame 22), there may be alternative embodiments which provide a locking assembly integrally formed with or carried by the floss frame for securing the frame to the handle.

With the first floss frame member 22A locked to handle 20, the operator may then use floss string 24 to floss between their teeth while handle 20 guides and maneuvers said string 24 in a desired path to perform a teeth or other oral cleaning function. After the oral care has been performed, the operator may unlock the locking assembly 64 by rotating locking plate 66 in an opposite direction about pivot axis 68. When the locking assembly 64 is unlocked, a user may removably slide the first floss frame 22A downwardly in the transverse direction towards the first side 16 and replace the first floss frame 22A with a second floss frame for later use.

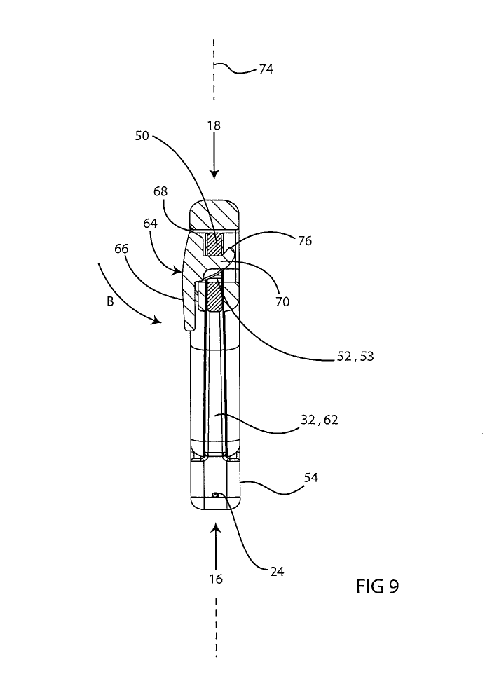

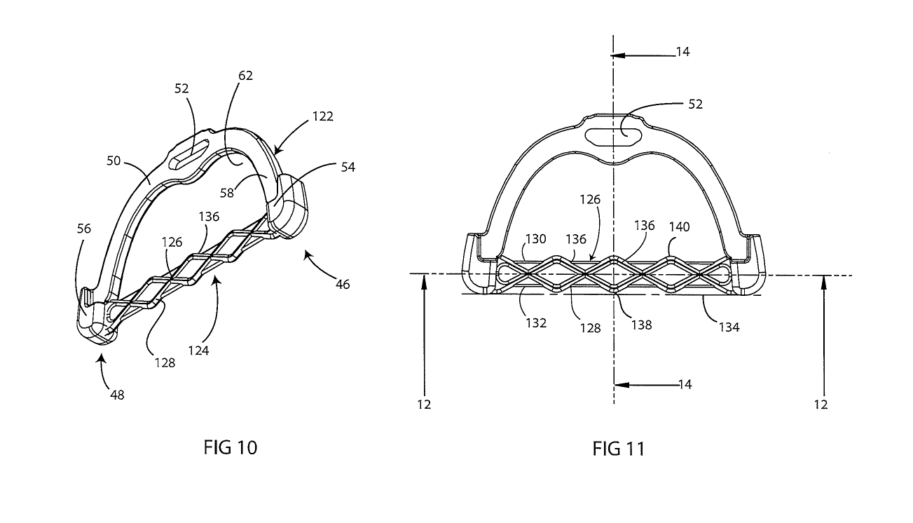

FIG. 10 through FIG. 15 depict an alternate embodiment of a floss frame in accordance with one aspect of the present disclosure generally at 122. Floss frame 122 carries and supports an improved floss assembly 124. The floss assembly 124 includes a flat floss portion 126 formed from a first material, and an elastomeric portion 128 defining a scraper formed from a second material different than the flat floss portion 126. The remaining portions of floss frame 122 that have similar reference numerals as floss frame 22 are not repeated herein for brevity but are to be understood to function and operate in a similar manner as previously described.

In accordance with an aspect of the present disclosure, the floss assembly 124 provides the benefit of being more gentle on the gums, relative to conventional floss, during a flossing action between teeth since assembly 124 includes the elastomeric material 128, which is atraumatic when sliding back and forth between teeth. This may also assist in preventing bleeding during the flossing action inasmuch as standard floss may sometimes cause gums to bleed during the flossing action.

As depicted in FIG. 10, floss assembly 124 extends longitudinally between the first enlarged member 54 and the second enlarged member 56. Generally, the longitudinal length of floss assembly 124 is longer than the transverse width thereof. Further, the transverse width of floss assembly 124 is greater than the lateral thickness thereof. In one particular embodiment, the floss assembly 124 is laterally centered such that it is coplanar with longitudinal plane 74 (FIG. 15).

As depicted in FIG. 11, the elastomeric material 128 of floss assembly 124 is overlaid and supported by the flat floss portion 126. The flat floss portion 126, when viewed from the side (as in FIG. 11), includes a first linear longitudinally extending edge 130 and an offset second linear longitudinally extending edge 132. Both edges 130, 132 are transversely offset towards aperture 52 relative to an end plane 134 of the frame 122. The end plane 134 is coplanar with the tips of the first and second enlarged members 54, 56.

With continued reference to FIG. 11, the elastomeric material 128 connectedly overlaying the flat floss portion 126 includes crossing linear portions forming a generally symmetric pattern. In one embodiment, there are at least two linear segments defined by material 128. The linear segments are collectively depicted at 136, and may be referred to as linear legs. At least one linear leg 136 extends at an angle atop the flat floss portion 126. In one particular embodiment, the linear leg 136 crosses the first edge 130 and the second edge 132 at an angle in a range from about 15° to about 75°. In a more particular embodiment, the linear leg 136 intersects the first edge 130 at an angle between 30° and 60° inclusive. In one embodiment, the linear leg 136 crosses above the first edge 130 at 60° and the second edge 132 at 30°. After crossing above the second edge 132, the linear leg 136 turns approximately 120° and extends back towards first edge 130. The location where the linear leg 136 alters direction defines an elastomeric bump 138 defining a convex outer surface that protrudes outwardly beyond second edge 132. The outermost apex portion of bump 138 is substantially coplanar with end plane 134. As the linear leg 136 extends towards the first edge 130 and crosses over the same, the linear leg 136 again alters direction by approximately 120° to thereby define a second bump 140 positioned outwardly from first edge 130. The second bump 140 is offset a distance closer to aperture 52 than first edge 130.

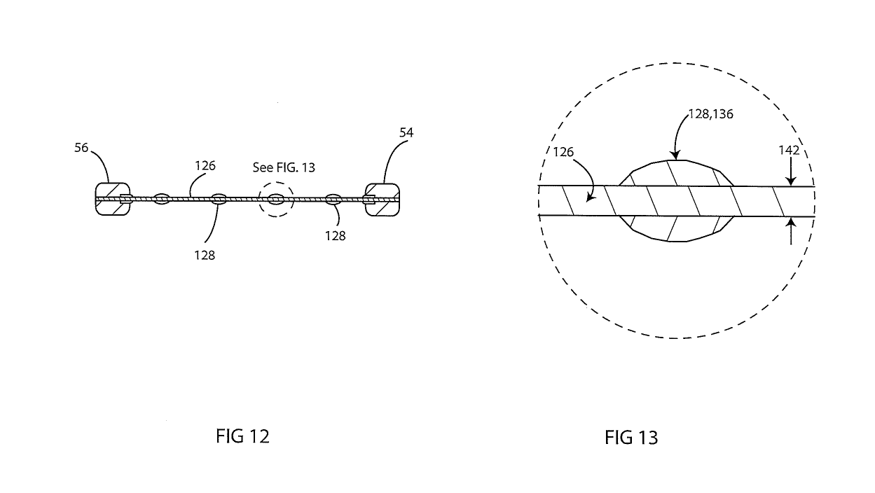

In one implementation, the elastomeric material 128 that defines the linear leg 136, first bump 138, and second bump 140 is formed from a more stiff material than the flat floss portion 126. As such, the stiffened material 128 enables the bumps 138, 140 to act as a scraper, such as a between-teeth scraper contacting a tooth surface (i.e., an inter-teeth scraper). Thus, the floss frame 122 has a dual purpose to enable teeth scraping as well as flossing, but provides the unique utility of the scraper and floss being carried by a single disposable and interchangeable frame 122. Stated otherwise, an embodiment of the present disclosure provides an oral care device comprising: a first end and a second end; a handle 20 defining the second end; a between-teeth scraper (i.e., material 128) proximate the first end; and a piece of flat floss 126 proximate the first end, wherein the flat floss and the scraper are in direct contact (as best seen in FIG. 12 and FIG. 13).

As depicted in FIG. 12 and FIG. 13, it is seen that the elastomeric material 128 is laid over the outer surface of flat floss portion 126. The thickness of flat floss portion 126 is represented by dimension 142. The thickness dimension 142 is similar to that of a conventional flat floss that has a generally rectangular cross section (i.e., linear and non-arcuate) rather than a conventional wire-based floss string (which is arcuate or circular in cross section) such as floss string 24 depicted previously herein. Flat floss portion 126 provides advantages of comfort during the flossing action. Further, flat floss portion 126 provides greater surface contact area during the flossing action thereby more effectively removing dental plaque from between the teeth and gums.

In some implementations, the outer surface of the elastomeric material 128 has a generally convex profile which is in contradistinction to the generally planar profile of the flat floss portion 126. Stated otherwise, one portion of the floss assembly 124 has a first shape in cross section and another portion of the floss assembly 124 has a second shape in cross section that is different than the first shape. This in turn reveals that the embodiments disclosed herein are not intended to be limiting and other shapes and features are entirely contemplated as functional equivalents to which is described herein.

The elastomeric material 128 which collectively defines the scraper is able to compress and contact tooth surfaces while the oral care device is maneuvered in a flossing action, such as reciprocating back- and forth, by the operator. Although the material 128 is stiffer than the flat floss 126, the material is still able to compressibly conform to the shape of the outer surface of the tooth that the material is moving therealong. The combination of flat floss 126 and scraper (i.e., material 128) enables a more effective means for removing debris from between teeth and removing debris/dental plaque from a tooth surface.

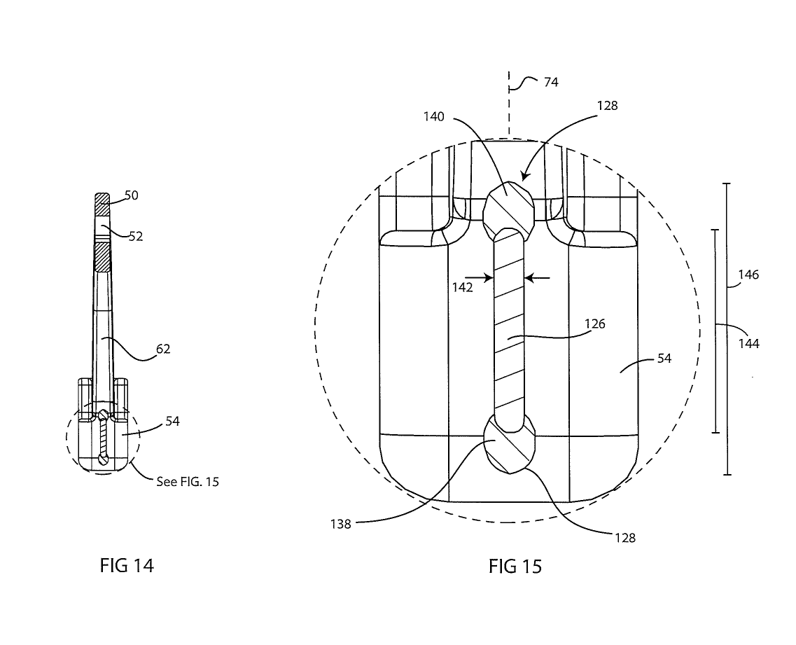

As depicted in FIG. 14 and FIG. 15, the transverse width 144 of flat floss portion 126 is shown as greater than the thickness dimension 142 of the flat floss portion 126. Moreover, a transverse width 146 which includes the transverse width associated with the first bump 138 and the second bump 140, is greater than the transverse width 144 associated with only the flat floss portion 126. The thickness dimension 142 is associated with the generally planar and flat sides of the flat floss portion 126 that extend transversely and longitudinally (into and out of the page).

In accordance with an aspect of the present disclosure, the hybrid of the flat floss portion 126 covered with the elastomeric stiffened material 128 creates a unique combination of a flossing member and a scraper in one single disposable device. Moreover, the hybrid of the flat floss portion 126 overlaid with material 128 provides an oral care device adapted to both floss between teeth and scrape a tooth surface, the oral care device including flat floss 126 having a rectangular cross section and a piece of material 128 having greater stiffness than the flat floss 126 directly overlaying an outer surface of the flat floss, wherein the piece of material 128 is at least partially arcuate in cross section. The advantages of which should be readily apparent inasmuch as it reduces part counts and enables the teeth scraping portion to be disposable, which is not ordinarily the case as depicted in some of the prior art previously described.

As used herein, the term “flossing device” refers to a reusable floss handle with a replacement floss member. Moreover, the term “scraper” refers to a material which is able to compressible contact the tooth surface while being maneuvered in a flossing action by the flossing device, however the tooth scraper could also be similarly utilized as a tongue scrapper as well.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, “can”, or “could”, or the like, be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A device comprising:
a scraper including a plurality of convex surfaces formed from a first material adapted to scrape between two adjacent teeth;
a piece of flat floss formed from a different second material having a non-arcuate cross section connected to the plurality of convex surfaces adapted to floss between the two adjacent teeth; and
wherein the device is adapted to both simultaneously floss between teeth and scrape tooth surface within a user's mouth.

2. The device of claim 1, further comprising:
a frame carrying the piece of flat floss; and
a handle that selectively connects with the frame.

3. The device of claim 2, further comprising:
a locking assembly on the handle to effectuate the selective connection between the handle and the frame.

4. The device of claim 1, wherein the plurality of convex surfaces of the scraper are uniformly formed from an elastomer material attached to an outer surface of the flat floss.

5. The device of claim 4, wherein the scraper defines linear segments extending angularly from the plurality of convex surfaces.

6. The device of claim 5, wherein at least one linear segment crosses over an edge of the piece of flat floss at an angle in a range from 15° to 75°.

7. The device of claim 1, further comprising:
an arcuate profile of the convex surfaces in cross section;
a planar profile of the flat floss in cross section; wherein the arcuate profile is exterior the planar profile.

8. The device of claim 1, further comprising:
an end plane associated with a frame carrying the piece of flat floss;
at least one apex from the plurality of convex surfaces coplanar with the end plane.

9. The device of claim 1, further comprising:
a longitudinal first edge and a longitudinal second edge on the piece of flat floss;
a transverse floss width measured from the first edge to the second edge;
wherein a portion of the plurality of convex surfaces is exterior to the first and second edges defining a greater transverse width associated with the plurality of convex surfaces.

10. The device of claim 1, wherein the plurality of convex surfaces are entirely exterior of an outer surface of the piece of flat floss.

11. An oral care device comprising:
a first end and a second end;
a handle defining the second end;
a scraper proximate the first end; and
a piece of flat floss proximate the first end, wherein the flat floss and the scraper are in direct contact.

12. The oral care device of claim 11, further comprising:
a frame selectively attachable to the handle;
wherein the frame carries the piece of flat floss and the scraper.

13. The oral care device of claim 12, further comprising:
a convex surface of the scraper contacting a planar surface of the flat floss.

14. The oral care device of claim 13, further comprising:
at least a portion of the scraper formed from an elastomer material.

15. The oral care device of claim 14, further comprising:
a lateral width of the scraper greater than a lateral width of the piece of flat floss.

16. The oral care device of claim 14, further comprising:
a transverse width of the scraper greater than a transverse width of the piece of flat floss.

17. The oral care device of claim 11, further comprising:
a longitudinal first edge spaced from a longitudinal second edge on the flat floss; and
at least a portion of the scraper positioned above the first edge at an angle in a range from 15° to 75°.

18. The oral care device of claim 17, further comprising:
two linear segments of the scraper angularly oriented from one another at an angle greater than 90°.

19. The oral care device of claim 11, further comprising:
a locking assembly on the handle to selectively lock a U-shaped frame to the first end of the handle;
wherein the U-shaped frame carries the flat floss and the scraper, and a longitudinal axis of the flat floss is parallel to a longitudinal axis of the handle.

20. An oral care device adapted to both simultaneously floss between teeth and scrape a tooth surface, the oral care device including flat floss having a rectangular cross section and a piece of material having greater stiffness than the flat floss directly overlaying an outer surface of the flat floss, wherein the piece of material is at least partially arcuate in cross section.
